(19) United States
(12) Patent Application Publication
(10) Pub. No.: US 2013/0299003 A1
(43) Pub. Date: Nov. 14, 2013

(54) Method And Device For Actuating Fluid Flow In A Microchannel

(71) Applicants: David J. Beebe, Monona, WI (US); Jay Warrick, Madison, WI (US); Edmond Young, Burnaby (CA)

(72) Inventors: David J. Beebe, Monona, WI (US); Jay Warrick, Madison, WI (US); Edmond Young, Burnaby (CA)

(21) Appl. No.: 13/467,560

(22) Filed: May 9, 2012

(51) Int. Cl. F16K 1/00

(52) U.S. Cl. 137/14; 251/318

(57) ABSTRACT

A method and device are provided for actuating fluid flow in a channel of a microfluidic device. The microfluidic device has a first and second ports communicating with the channel. The channel is filled with a fluid and oscillatory movement of the fluid in the channel is generated in response to movement of an actuator between a first retracted position and a second extended position.

### FIELD OF THE INVENTION

This invention relates generally to microfluidics, and in particular, to a method and a device for actuating fluid flow in a microchannel.

### BACKGROUND AND SUMMARY OF THE INVENTION

Cell adhesion plays a key role in the mechanics and cell-cell signaling involved at the cellular level. For this reason, cell adhesion is an important topic of study in many areas such as developmental biology, tissue engineering, immunology, regenerative medicine and cancer. Despite the recognized role of cell adhesion in these areas, characterization of cell adhesion is typically limited to biochemical assays which measure expression of specific adhesion molecules. Methods to measure the function of a particular adhesion molecule (i.e. an assay to determine how the molecule influences adhesion strength) are generally impractical for most laboratory settings or do not provide enough flexibility to provide relevant readouts.

Currently, cell adhesion assays are implemented using a few, known approaches, namely: atomic force microscopy (AFM), micropipette manipulation, centrifugation, and fluid flow. AFM and micropipette manipulation are methods intended for studying single cells and require significant expertise. Hence, these methods are not appropriate for characterizing populations of cells. Centrifugation is simple process which integrates well with a laboratory setting. Yet, centrifugation cannot be used to interrogate aspects of dynamic cell adhesion (i.e. when the cell is attempting to adhere to a substrate in the presence of fluid flow using weak, non-specific interactions) and cannot mimic physiologic fluid shear stresses. Physiologic fluid shear stresses have been shown to be of importance in subsequent static adhesion processes (i.e. formation of high-strength anchoring points to the substrate or cell neighbors).

Cell adhesion assays that use fluid flow employ the use of spinning discs, microfluidic flow-through chambers or simply pipetting fluid over cells. Spinning disc assays are only useful for studying static adhesion characteristics. Flow-through chambers employ the more physiologic phenomena of fluid shear stress and are well-suited for microscopes to allow study of both dynamic and static adhesion events. However, the use of flow-through chambers has significant drawbacks due to the tubes and fluidic connections required. Finally, manual pipette-driven flow lacks sensitivity and the resulting data may be somewhat limited. As such, it can be appreciated that there is a significant unmet need for an easy to use device and method for actuating fluid flow in a microchannel.

Therefore, it is a primary object and feature of the present invention to provide a method and a device for actuating fluid flow in a microchannel.

It is a further object and feature of the present invention to provide a method and a device for actuating fluid flow in a microchannel which may be used in the performance of cell adhesion assays.

It is a still further object and feature of the present invention to provide a method and a device for actuating fluid flow in a microchannel which is simple to use and inexpensive to manufacture.

In accordance with the present invention, a device is provided for actuating fluid flow in a channel of a microfluidic device. The channel has a port communicating with a surface of the microfluidic device. The device includes an actuator extending over the port and being movable between a first retracted position and a second extended position. Movement of the actuator between the retracted position and the extended position causes fluid flow in the channel. An activation signal selectively communicates with the actuator for moving the actuator between the retracted position and the extended position.

A flexible membrane extends over the port and has inner and outer surfaces. The inner surface of the membrane partially defines a chamber having a pressure and being in communication with the port. The actuator engages the outer surface of the membrane in the extended position so as to increase the pressure in the chamber. The increase in pressure in the chamber actuates the fluid into the channel. Movement of the actuator from the extended position to the retracted position draws fluid through the channel towards the port. It is contemplated for the activation signal to be a voltage signal or a magnetic field.

Alternatively, a fluid bridge extends between the actuator and the fluid in the port such that movement of the actuator to the extended position urges the fluid into the channel. In addition, movement of the actuator from the extended position to the retracted position draws fluid through the channel towards the port. It can be appreciated that, as described, movement of the actuator between the retracted position and the extended position causes oscillatory movement of the fluid in the channel.

In accordance with a further aspect of the present invention, a method is provided for actuating fluid flow in a channel of a microfluidic device. The microfluidic device has first and second ports communicating with the channel. The method includes the step of filling the channel with a fluid. Thereafter, a pressure is selectively generated at the second port so as to generate flow of the fluid through the channel toward the first port.

The step of selectively generating a pressure at the second port includes the step of moving an actuator between a first non-actuated position and a second actuated position. The movement of the actuator causes oscillatory movement of the fluid in the channel. The step of moving the actuator includes the step of generating a signal. The actuator moves in response to the signal. The signal may be a voltage signal or a magnetic field.

In a first embodiment, the actuator may include a flexible membrane extending over the second port and having inner and outer surfaces. The inner surface of the membrane partially defines a chamber having a pressure and being in communication with the second port. A movable arm is engageable with the outer surface of the membrane. Alternatively, the actuator may include a movable arm and a fluid bridge extending between the actuator and the fluid in the second port of the channel.

In accordance with a still further aspect of the present invention, a method is provided for actuating fluid flow in a channel of a microfluidic device. The microfluidic device has a first and second ports communicating with the channel. The method includes the step of filling the channel with a fluid. Oscillatory movement of the fluid is generated in the channel in response to movement of an actuator between a first retracted position and a second extended position.

It is contemplated for fluid to flow in the channel from the first port towards the second port such that the oscillatory movement of the fluid in the channel is superimposed on the flow of the fluid in the channel. The actuator moves in response to the signal, such as a voltage signal or a magnetic field. In a first embodiment, the actuator includes a flexible membrane extending over the second port and having inner and outer surfaces. The inner surface of the membrane partially defines a chamber having a pressure and being in communication with the second port. A movable arm is engageable with the outer surface of the membrane. Alternatively, the actuator includes a movable arm and a fluid bridge extending between the movable arm and the fluid in the second port of the channel.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of a microfluidic device in accordance with the present invention;

FIG. 2 is a cross sectional view of the device of the present invention taken along line 2-2 of FIG. 1 showing the device in a non-actuated position;

FIG. 3 is a cross sectional view of the device of the present invention, similar to FIG. 2, showing the device in an actuated position;

FIG. 4 is an isometric view of an alternate embodiment of a microfluidic device in accordance with the present invention;

FIG. 5 is a cross sectional view of the device of the present invention taken along line 5-5 of FIG. 4 showing the device in a first, non-actuated position;

FIG. 6 is a cross sectional view of the device of the present invention, similar to FIG. 5, showing the device in an actuated position; and

FIG. 7 is a cross sectional view of the device of the present invention, similar to FIG. 5, showing the device in a second, non-actuated position.

### DETAILED DESCRIPTION OF THE DRAWINGS

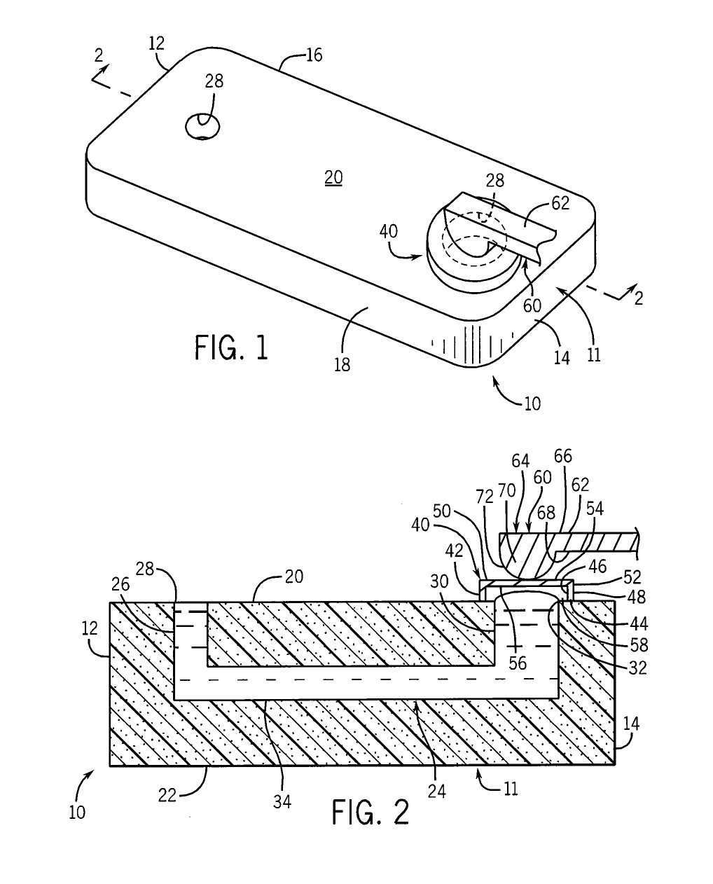

Referring to FIG. 1, a microfluidic device in accordance with the present invention is generally designated by the reference numeral 10. Microfluidic device 10 may be formed from polystyrene (PS), however, other materials are contemplated as being within the scope of the present invention. In the depicted embodiment, microfluidic device 10 includes base 11 having first and second ends 12 and 14, respectively; first and second sides 16 and 18, respectively; and upper and lower surfaces 20 and 22, respectively. Channel 24 extends through base 11 of microfluidic device 10 and includes a first vertical portion 26 terminating at an input port 28 that communicates with upper surface 20 of base 11 of microfluidic device 10 and a second vertical portion 30 terminating at an output port 32 also communicating with upper surface 20 of base 11 of microfluidic device 10. First and second vertical portions 26 and 30, respectively, of channel 24 are interconnected by and communicate with horizontal portion 34 of channel 24. The dimension of channel 34 connecting input port 28 and output port 32 is arbitrary. It can be appreciated that the diameter of output port 32 is substantially greater than the diameter of input port 28, for reasons hereinafter described.

Microfluidic device 10 further includes flexible membrane 40, for reasons hereinafter described. By way of example, flexible membrane 40 has a generally cylindrical configuration, however, other configurations are possible without deviating from the scope of the present invention. Flexible membrane 40 is defined by sidewall 42 extending about output port 32 and having a lower edge 44 in contact with upper surface 20 so as to form a fluidic seal therewith. Sidewall 42 is defined by inner surface 46 and outer surface 48. Flexible membrane 40 further includes disc-shaped, upper layer 50 having a radially outer edge 52 coincident with outer surface 48 of sidewall 42. Upper layer 50 is defined by upper surface 54 and lower surface 56. Lower surface 56 of upper layer 50 and inner surface 46 of sidewall 42 define chamber 58 in communication with output port 32 of channel 24, for reasons hereinafter described.

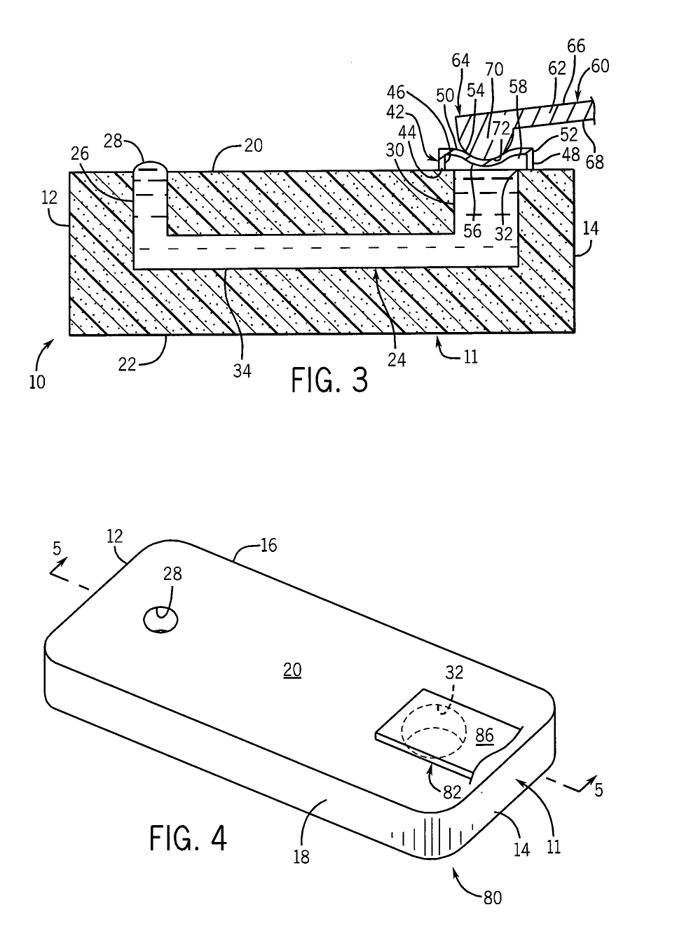

Microfluidic device 10 also includes cantilevered actuator 60 defined by arm 62 having a first end (not shown) operatively connected to a signal source and a second, terminal end 64. Arm 62 includes upper surface 66 and downwardly directed lower surface 68. Hemispherical-shaped contact 70 depends from lower surface 68 of arm 62 and includes a contact surface 72 in engagement with upper surface 54 of upper layer 50 of flexible membrane 40. It is contemplated for arm 62 to deflect in response to a predetermined signal between a first non-deflected configuration, FIG. 2, and a deflected configuration, FIG. 3, wherein contact 70 depresses upper layer 50 so as to increase the pressure in chamber 58 within flexible membrane 40. By way of example, arm 62 may take the form of a piezo actuator which deflects in response to the application of electrical energy thereto.

In operation, channel 24 in base 11 of microfluidic device 10 is filled with a user-desired fluid. The absolute value of the radius of curvature of the fluid at input port 28 of channel 24 is smaller than the absolute value of the radius of curvature of fluid at output port 32 of channel 24. As such, a larger pressure exists on input port 28 of channel 24. The resulting pressure gradient causes the fluid at input port 28 to flow from input port 28 through channel 24 towards output port 32 of channel 24. It can be understood that by sequentially depositing additional drops of fluid on input port 28 of channel 24, the resulting pressure gradient will cause the drops deposited on input port 28 to flow through channel 24 towards output port 32 of channel 24. As a result, the fluid flows through channel 24 from input port 28 to output port 32.

After filing channel 24 with the user-desired fluid, a predetermined actuation signal, such as a voltage signal, is applied to actuator 60 by the signal source so as to deflect arm 62 to its deflected configuration, FIG. 3. As arm 62 is deflected, contact 70 exerts a force on and depresses upper layer 50 of flexible membrane 40 so as to increase the pressure in chamber 58 within flexible membrane 40. The pressure change in chamber 58 exerts pressure on the fluid at output port 32 of channel 24 so as to actuate the fluid towards input port 28 of channel 24. As a result, the fluid flows through channel 24 from output port 32 to input port 28. Upon removal (or reduction) of the predetermined actuation signal to actuator 60, arm 62 returns to (or approaches) the non-deflected configuration, FIG. 2. As arm 62 returns to the non-deflected configuration, the force exerted by contact 70 on upper layer 50 of flexible membrane 40 is relieved such that the pressure in chamber 58 within flexible membrane 40 is reduced. The pressure change in chamber 58 draws fluid towards output port 32 of channel 24. As a result, the fluid flows through channel 24 from input port 28 to output port 32. It can be appreciated that by sequentially supplying and removing the actuation signal to actuator 60, the oscillatory movement of the fluid in channel 24 toward and away from input port 28 occurs.

It is noted that the oscillatory movement of the fluid in channel 24 toward and away from input port 28 is superimposed on the flow of fluid in channel 24 resulting from the different absolute values of the radii of curvatures of input port 28 and output port 32, heretofore described. However, since the oscillatory movement of the fluid is significantly stronger than the flow of fluid in channel 24 resulting from the different absolute values of the radii of curvatures of input port 28 and output port 32, a drop placed on input port 28 will hardly flow toward output port 32. More specifically, because the pressure in chamber 58 builds up quickly in response to depression of upper layer 50 of flexible membrane 40 by contact 70, the pressure acts to deter the flow of fluid in channel 24 resulting from the different absolute values of the radii of curvatures of input port 28 and output port 32.

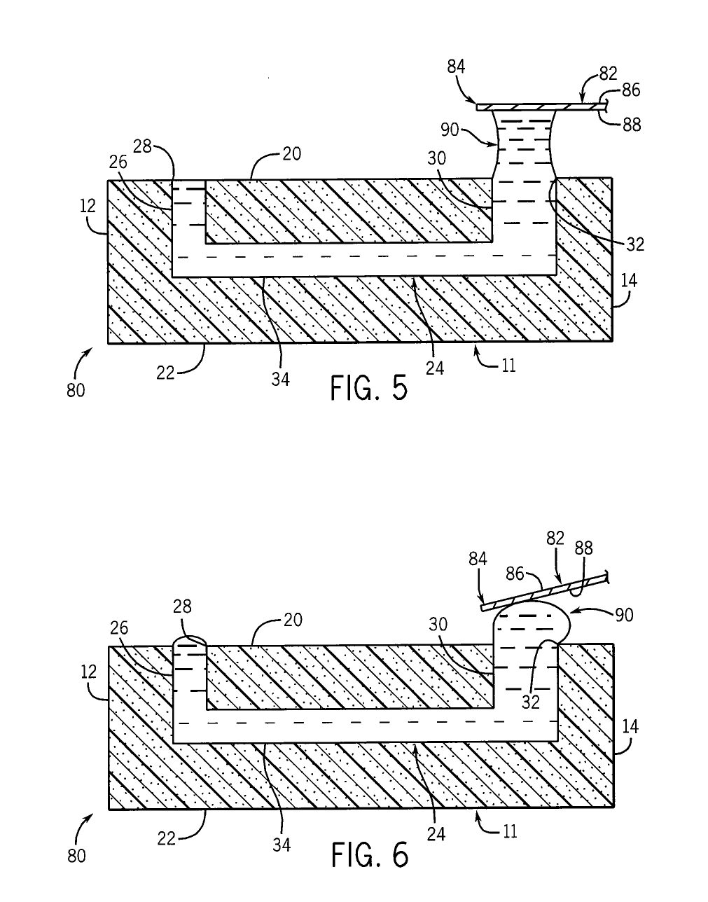

Referring to FIGS. 4-7, an alternate embodiment of a microfluidic device in accordance with the present invention is generally designated by the reference numeral 80. Microfluidic device 80 includes base 11, as heretofore described, and a cantilevered actuator 82. Actuator 82 has first end (not shown) operatively connected to a support structure for supporting actuator 82 above upper surface 20 of base 11 and a second, terminal end 84 axially aligned with output port 32 of channel 24. Actuator 82 includes upper surface 86 and downwardly directed lower surface 88. It is contemplated for actuator 82 to deflect in response to a predetermined signal between a first non-deflected configuration, FIG. 5, and a deflected configuration, FIG. 6. By way of example, actuator 82 may be magnetically responsive such that actuator 82 deflects in response to the application of a magnetic signal having a first polarity generated by the signal source.

In operation, channel 24 in base 11 of microfluidic device 80 is filled with a user-desired fluid and fluid bridge 90 is provided between terminal end 84 of actuator 82 and the fluid at output port 32 of channel. As previously noted, the absolute value of the radius of curvature of the fluid at input port 28 of channel 24 is smaller than the absolute value of the radius of curvature of fluid at output port 32 of channel 24. As such, a larger pressure exists on input port 28 of channel 24. The resulting pressure gradient causes the fluid at input port 28 to flow from input port 28 through channel 24 towards output port 32 of channel 24. It can be understood that by sequentially depositing additional drops of fluid on input port 28 of channel 24, the resulting pressure gradient will cause the drops deposited on input port 28 to flow through channel 24 towards output port 32 of channel 24. As a result, the fluid flows through channel 24 from input port 28 to output port 32.

An actuation signal, such as a magnetic signal, is applied to actuator 82 by the signal source so as to deflect actuator 82 from the non-deflected configuration, FIG. 5, to the deflected configuration, FIG. 6. As actuator 82 is deflected, terminal end 84 of actuator 82 exerts a force on fluid bridge 90, and hence, on the fluid at output port 32 of channel 24 so as to urge the fluid towards input port 28 of channel 24. As a result, the fluid flows through channel 24 from output port 32 towards input port 28. Upon removal of the predetermined actuation signal, actuator 82 returns to (or approaches) the non-deflected configuration, FIG. 5. As actuator 82 returns to the non-deflected configuration, actuator 82 draws fluid bridge 90, and hence, the fluid in channel 24 towards output port 32. As a result, the fluid flows through channel 24 from input port 28 toward output port 32. It can be appreciated that by sequentially supplying and removing the actuation signal to actuator 82, oscillatory movement of the fluid in channel 24 toward and away from input port 28 occurs.

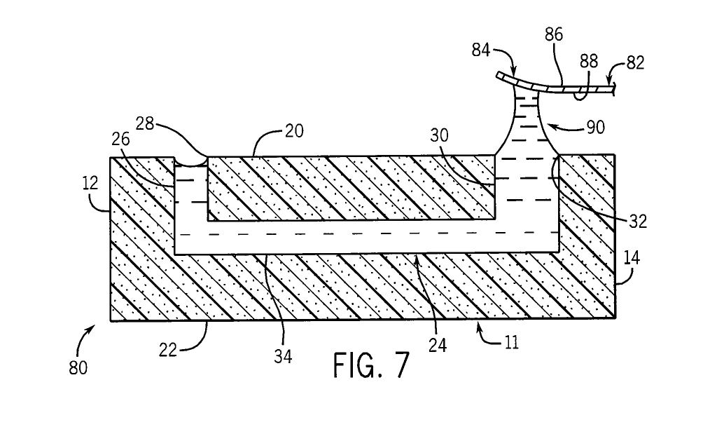

Alternatively, instead of removing the actuation signal as heretofore described, the polarity of the magnetic actuation signal may be reversed. In response to the reversal of the polarity of the magnetic actuation signal, actuator 82 is deflected in a second, opposite direction, FIG. 7. As actuator 82 moves in the second, opposite direction away from output port 32, actuator 82 draws fluid bridge 90, and hence, the fluid in channel 24 towards output port 32. As a result, the fluid flows through channel 24 from input port 28 toward output port 32. It can be appreciated that by sequentially changing the polarity of the actuation signal to actuator 82, oscillatory movement of the fluid in channel 24 toward and away from input port 28 occurs.

As previously described, the oscillatory movement of the fluid in channel 24 toward and away from input port 28 is superimposed on the flow of fluid in channel 24 resulting from the different absolute values of the radii of curvatures of input port 28 and output port 32. However, since the oscillatory movement of the fluid is significantly stronger than the flow of fluid in channel 24 resulting from the different absolute values of the radii of curvatures of input port 28 and output port 32, a drop placed on input port 28 will hardly flow toward output port 32.

It can be appreciated that the devices and methods heretofore described allow for a user to control over the amplitudes and frequencies of oscillatory movement of the fluid in channel 24 by simply adjusting the magnitude, frequency and/or polarity of the actuation signals provided to actuators 62 and 82, thereby enhancing the ability for quantification of cells and cell properties. Further, the simple set-up and operation of devices 10 and 80 herein described renders these devices more appealing than traditional methods using tubes, pumps, and syringes. Also, since the fluid in channel 24 is utilized to generate the oscillatory movement of the fluid in channel 24, costs can be reduced for some assays due to the savings in reagents or media.

Various modes of carrying out the invention are contemplated as being within the scope of the following claims particularly pointing out and distinctly claiming the subject matter which is regarded as the invention.

1. A device for actuating fluid flow in a channel of a microfluidic device, the channel having a port communicating with a surface of the microfluidic device, the device comprising:
an actuator extending over the port and being movable between a first retracted position and a second extended position wherein movement of the actuator between the retracted position and the extended position causes fluid flow in the channel; and
an activation signal selectively in communication with the actuator for moving the actuator between the retracted position and the extended position.

2. The device of claim 1 further comprising a flexible membrane extending over the port and having inner and outer surfaces, the inner surface of the membrane partially defining a chamber having a pressure and being in communication with the port.

3. The device of claim 2 wherein the actuator engages the outer surface of the membrane in the extended position so as to increase the pressure in the chamber, the increase in pressure in the chamber urging the fluid into the channel.

4. The device of claim 2 wherein movement of the actuator from the extended position to the retracted position draws fluid through the channel towards the port.

5. The device of claim 1 wherein the activation signal is a voltage signal.

6. The device of claim 1 wherein the activation signal is a magnetic field.

7. The device of claim 1 further comprising a fluid bridge extending between the actuator and the fluid in the port, wherein movement of the actuator to the extended position urges the fluid into the channel.

8. The device of claim 7 wherein movement of the actuator from the extended position to the retracted position draws fluid through the channel towards the port.

9. The device of claim 1 wherein movement of the actuator between the retracted position and the extended position causes oscillatory movement of the fluid in the channel.

10. A method for actuating fluid flow in a channel of a microfluidic device, the microfluidic device having first and second ports communicating with the channel, the method comprising the steps of:
filling the channel with a fluid; and
selectively generating a pressure at the second port so as to generate flow of the fluid through the channel toward the first port.

11. The method of claim 10 wherein the step of selectively generating a pressure at the second port includes the step of moving an actuator between a first non-actuated position and a second actuated position, the movement of the actuator causing oscillatory movement of the fluid in the channel.

12. The method of claim 11 wherein the step of moving the actuator includes the step of generating a signal, the actuator moving in response to the signal.

13. The method of claim 12 wherein the signal is a voltage signal.

14. The method of claim 12 wherein the signal is a magnetic field.

15. The method of claim 11 wherein the actuator includes:
a flexible membrane extending over the second port and having inner and outer surfaces, the inner surface of the membrane partially defining a chamber having a pressure and being in communication with the second port; and
a movable arm engageable with the outer surface of the membrane.

16. The method of claim 11 wherein the actuator includes:
a movable arm; and
a fluid bridge extending between the actuator and the fluid in the second port of the channel.

17. A method for actuating fluid flow in a channel of a microfluidic device, the microfluidic device having first and second ports communicating with the channel, the method comprising the steps of:
filling the channel with a fluid; and
changing the pressure at the second port to generate oscillatory movement of the fluid in the channel.

18. The method of claim 17 wherein the step of changing the pressure includes the steps of providing an actuator in communication with the fluid in the channel at the second port; and moving the actuator between a first retracted position and a second extended position.

19. The method of claim 17 wherein fluid flows in the channel from the first port towards the second port; and wherein the oscillatory movement of the fluid in the channel is superimposed on the flow of the fluid in the channel.

20. The method of claim 18 comprising the additional step of generating a signal, the actuator moving in response to the signal.

21. The method of claim 20 wherein the signal is a voltage signal.

22. The method of claim 20 wherein the signal is a magnetic field.

23. The method of claim 18 wherein the actuator includes:
a flexible membrane extending over the second port and having inner and outer surfaces, the inner surface of the membrane partially defining a chamber having a pressure and being in communication with the second port; and
a movable arm engageable with the outer surface of the membrane.

24. The method of claim 18 wherein the actuator includes:
a movable arm; and
a fluid bridge extending between the movable arm and the fluid in the second port of the channel.
